(19) United States
(12) Patent Application Publication
(10) Pub. No.: US 2008/0120696 A1
(43) Pub. Date: May 22, 2008

(54) Method and Product for Generating Network and Server Analytics

(76) Inventor: Aditya Desaraju, Oxford (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/938,293

(22) Filed: Nov. 12, 2007

(30) Foreign Application Priority Data
Nov. 21, 2006 (IN) 2158/CHE/2006

(51) Int. Cl. G06F 7/04

(52) U.S. Cl. 726/3

(57) ABSTRACT

A method and system for generating network and server analytics. The method comprises a network server intercepting an access request for access to a network information technology resource the network server saving details of the access request the network server sending an authorization request to a validator the network server receiving from the validator authorization information comprising a denial or allowance of the access request the network server saving at least a portion of the authorization information, and outputting a report comprising information derived from the details of the access request and the portion of the authorization information.

### BACKGROUND OF THE INVENTION

Currently, users of web servers such as the Microsoft IIS web server and the Apache Unix based web server manage these resources to make best use of them with maximum efficiency. One existing technique for determining the best management parameters for such servers is network (such as the internet) and server analytics.

However, users must still predict what loads and traffic servers will experience, and generally their predictions are poor, often leading to highly inaccurate server load balancing procedures. In addition, users would like to know from where their sites are accessed, so they can deploy advertising resources with precision; failing to do so generally results in unnecessary or wasted advertising expenditure. Also, existing system generally lack or cannot provide suitable performance metrics (in terms of clicks per page, etc). Moreover, data should in principle be reported to some centralized data collection centre, but this is typically not conveniently possible.

Some vendors provide data of the types described above for a particular resource or resource type, but fail to provide centralized calculation and display of data for all resources, that is, their servers lack any centralized policy that can help collect data in one location.

### BRIEF DESCRIPTION OF THE DRAWING

In order that the invention may be more clearly ascertained, embodiments will now be described, by way of example, with reference to the accompanying drawing, in which:

FIG. 1 is a schematic view of a software product for generating internet analytics according to an embodiment of the present invention.

FIG. 2 is a flow diagram of a method for generating internet analytics according to an embodiment of the present invention.

### DETAILED DESCRIPTION OF THE EMBODIMENTS

There will be described a method and system for generating network and server analytics. In one embodiment, there is provided a method for generating network and server analytics, comprising a network server intercepting an access request for access to a network information technology resource the network server saving details of the access request the network server sending an authorization request to a validator the network server receiving from the validator authorization information comprising a denial or allowance of the access request the network server saving at least a portion of the authorization information, and outputting a report comprising information derived from the details of the access request and the portion of the authorization information.

There will also be described a computing system for generating network and server analytics, and a software product that, when executed on a computing device or system, controls the device or system to perform the above-described method for generating network and server analytics.

The following description refers to HP OpenView Select Access (Select Access), which is identity management software for secure user access to information technology resources and hence is used to regulate access to protected resources.

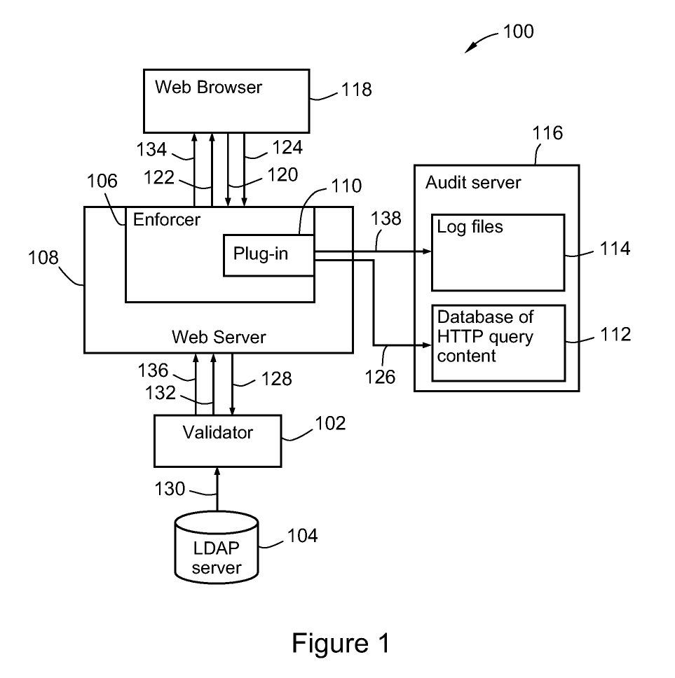

A software product for generating internet and server analytics according to an embodiment of the present invention is depicted schematically at 100, installed in a web based computing environment, in FIG. 1. Referring to FIG. 1, the product 100 comprises a validator 102, a lightweight directory access protocol server (LDAP server) 104 and an enforcer 106 plugged into a web server 108. Validator 102, LDAP server 104 and enforcer 106 perform, amongst other functions (described below) all the functions of the validator, LDAP server and enforcer of Select Access. Thus, LDAP server 104 contains a policy store (not shown), and enforcer 106 parses every request to access a resource (essentially a URL) to determine whether the authenticated user making the request is authorized to use the requested resource. In addition, enforcer 106 includes a plug-in 110 that directs HTTP query content to a database 112 (or, alternatively, to raw log files 114) of HTTP query content—for use in determining internet analytics—maintained by an audit server 116.

Enforcer 106 parses the URL to check conformity and other information, and saves these details to log files 114. Enforcer 106 employs plug-in 110 to intercept and dump additional details—such as HTTP variables (such as previous link), type of data and the identity of the server at which the URL was processed—to database 112. Since enforcer 106 already parses every HTTP request, the extra computing overhead of extracting or determining these HTTP request details is low or minimal.

Product 100 is not the sole identity management software product according to this embodiment that directs such HTTP request details to database 112. In due course, therefore, database 112 accumulates data from product 100 and other, like software products; this aggregated data in database 112 can then be correlated and used to determine useful information, such as with HP OpenView Select Audit software running on audit server 116. For example, aggregated data in database 112 can be used to determine user statistics, how many times a web site was hit at each server, and the most previous links used to get to the link. Such results can then be output by audit server 114 in the form of a report or reports (which may comprise information in any suitable form, including as statistics or graphs), centralized by and customized under the control of (typically) a system administrator. These reports, statistics and graphs therefore allow the system administrator to optimize his or her web resources accordingly.

It should be noted that the software product 100 can provide a variety of outputs, based on each user's security and access environment data. For example, product 100 can product a report on how many users accessed a particular web server from a particular subnet, or how many accesses were denied by a particular LDAP server that belonged to a particular country. Such a report might indicate that a particular user logged in 10 times yesterday, comprising 6 times from Australia and the remaining times from the United Kingdom. In this way, product 100 combines the advantages of Select Access and internet analytics to get an overall view of security and internet use.

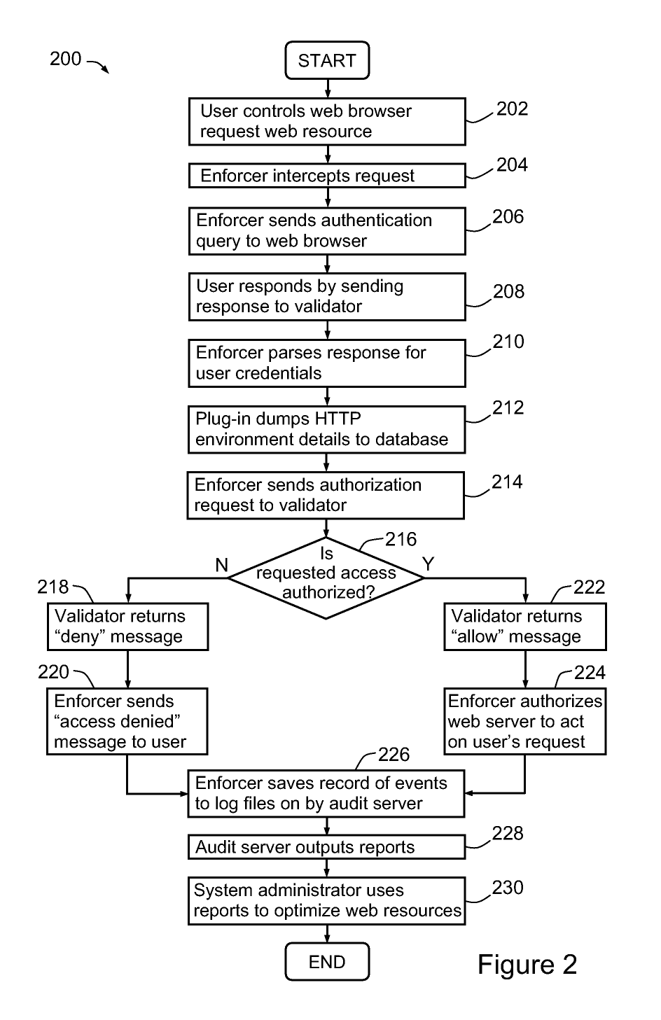

FIG. 2 is a flow diagram of the method 200 employed according to this embodiment for generating internet and server analytics. At step 202, a user controls a web browser 118 to send an HTTP request 120 for a web resource (not shown) to be accessed via web server 108. At step 204, enforcer 106 intercepts the request 120 and, at step 206, sends an authentication and authorization query 122 to web browser 118.

At step 208, the user responds to the authentication and authorization query 122 by sending a response 124 that includes the user's credentials to enforcer 106. At step 210, enforcer 106 parses the response 124 for the user credentials and, at step 212, plug-in 110 of enforcer 106 dumps the HTTP environment details 126 of the request 120 to database 112. At step 214, enforcer 106 sends an authorization request 128 to validator 102. At step 216, validator 102 uses data 130 returned by LDAP server 204 to decide whether the user is authorized to have access to the requested IT resource. If not, processing continues at step 218 where validator 102 returns a “deny” (access) message 132 to enforcer 106 and, at step 220 enforcer 106 sends an “access denied” message 134 to the user. Processing then continues at step 226.

If at step 216 validator 102 determines that the user is authorized to have access to the requested IT resource, processing continues at step 222, where validator 102 sends an “allow” (access) message 136 to enforcer 106 then, at step 224, enforcer 106 authorizes web server 108 to act on the user's request 120. Processing then continues at step 226

At step 226, enforcer 106 saves a record 138 of these events (including the authorization “allow” or “deny” message and associated details) to log files 114 maintained by audit server 116; at step 228 audit server 116 outputs one or more reports, customized as controlled by (typically) the system administrator. At step 230, the system administrator uses these reports as the basis to optimize his or her web resources, then processing ends.

Thus, software product 100 allows the central reporting of usage statistics, and can be coupled to other HP OpenView products to provide more meaningful web services.

In some embodiments the necessary software for controlling each component of the software product 100 of FIG. 1 to perform the method 200 of FIG. 2 is provided on a data storage medium. It will be understood that, in this embodiment, the particular type of data storage medium may be selected according to need or other requirements. For example, instead of a CD-ROM the data storage medium could be in the form of a magnetic medium, but any data storage medium will suffice.

The foregoing description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A method for generating network and server analytics, comprising:
a network server intercepting an access request for access to a network information technology resource;
said network server saving details of said access request;
said network server sending an authorization request to a validator;
said network server receiving from said validator authorization information comprising a denial or allowance of said access request;
said network server saving at least a portion of said authorization information; and
outputting a report comprising information derived from said details of said access request and said portion of said authorization information.

2. A method as claimed in claim 1, further comprising:
said network server responding to said access request with a request for authentication;
said network server receiving in response to said request for authentication a response comprising user credentials; and
said network server parsing said response for user credentials.

3. A method as claimed in claim 1, further comprising optimizing one or more network resources based on said report.

4. A method as claimed in claim 1, including saving said details of said access request to a database.

5. A method as claimed in claim 1, including saving said portion of said authorization information to a database.

6. A method as claimed in claim 1, wherein said denial or allowance of said access request is determined by reference to a directory access protocol server.

7. A computing system for generating network and server analytics, comprising:
a processor;
an output; and
program instructions executable by said processor to control said computing system to:
intercept an access request for access to a network information technology resource;
save details of said access request;
send an authorization request to a validator;
respond to receipt from said validator authorization information comprising a denial or allowance of said access request by saving at least a portion of said authorization information; and
respond to a user request for a report by outputting with said output a report comprising information derived from said details of said access request and said portion of said authorization information.

8. A computing system as claimed in claim 7, wherein said computing system includes said validator.

9. A computing system as claimed in claim 7, configured to save said details of said access request and said portion of said authorization information to a database.

10. A computing system as claimed in claim 9, wherein said computing system includes said database.

11. A computer readable medium provided with program data that, when executed on a computing device or system, controls the device or system to perform the method of claim 1.

12. A software product that, when executed on a computing device or system, controls the device or system to perform the method of claim 1.
